(19) United States
(12) Patent Application Publication
(10) Pub. No.: US 2014/0080032 A1
(43) Pub. Date: Mar. 20, 2014

(54) CONDUCTIVE MESH SUPPORTED ELECTRODE FOR FUEL CELL

(71) Applicants: Ford Motor Company, Dearborn, MI (US); Daimler AG, Stuttgart (DE)

(72) Inventors: Tatyana Soboleva, Vancouver (CA); Jasna Jankovic, Vancouver (CA); Mohammed Hussain, Richmond (CA); Jingwei Hu, Burnaby (CA); Andreas Putz, North Vancouver (CA)

(73) Assignees: Ford Motor Company, Dearborn, MI (US); Daimler AG, Stuttgart (DE)

(21) Appl. No.: 14/022,252

(22) Filed: Sep. 10, 2013

Related U.S. Application Data
(60) Provisional application No. 61/701,628, filed on Sep. 15, 2012.

(51) Int. Cl. H01M 4/86

(52) U.S. Cl. CPC H01M 4/8605
USPC 429/482; 429/523; 429/524; 427/115

(57) ABSTRACT

Electrically conductive meshes with pore sizes between about 20 and 3000 nanometers and with appropriately selected strand geometry can be used as engineered supports in electrodes to provide for improved performance in solid polymer electrolyte fuel cells. Suitable electrode geometries have essentially straight, parallel pores of engineered size. When used as a cathode, such electrodes can be expected to provide a substantial improvement in output voltage at a given current.

### BACKGROUND

1. Field of the Invention

The present invention pertains to solid polymer electrolyte fuel cells, and particularly to improved engineered supports for the electrodes therein.

2. Description of the Related Art

Solid polymer electrolyte fuel cells electrochemically convert reactants, namely fuel (such as hydrogen) and oxidant (such as oxygen or air), to generate electric power. These cells generally employ a proton conducting polymer membrane electrolyte between two electrodes, namely a cathode and an anode. A structure comprising a proton conducting polymer membrane sandwiched between two electrodes is known as a membrane electrode assembly (MEA). MEAs in which the electrodes have been coated onto the membrane electrolyte to form a unitary structure are commercially available and are known as a catalyst coated membrane (CCM). In a typical fuel cell, flow field plates comprising numerous fluid distribution channels for the reactants are provided on either side of a MEA to distribute fuel and oxidant to the respective electrodes and to remove by-products of the electrochemical reactions taking place within the fuel cell. Water is the primary by-product in a cell operating on hydrogen and air reactants. Because the output voltage of a single cell is of order of 1V, a plurality of cells is usually stacked together in series for commercial applications. Fuel cell stacks can be further connected in arrays of interconnected stacks in series and/or parallel for use in automotive applications and the like.

Catalysts are used to enhance the rate of the electrochemical reactions which occur at the cell electrodes. Catalysts based on noble metals such as platinum are typically required in order to achieve acceptable reaction rates, particularly at the cathode side of the cell. To achieve the greatest catalytic activity per unit weight, the noble metal is generally disposed on a corrosion resistant support with an extremely high surface area, e.g. high surface area carbon particles. However, noble metal catalyst materials are relatively quite expensive. In order to make fuel cells economically viable for automotive and other applications, there is a need to reduce the amount of noble metal (the loading) used in such cells, while still maintaining similar power densities and efficiencies. This can be quite challenging.

In order to make the most efficient use of the catalyst, it is also important to be able to readily transport the various required reactant species to available catalyst surface and to readily transport the various product species away. Again, the cathode side of the fuel cell poses the greater challenge at present. At the cathode electrode, the required reactants include oxygen, hydrogen ions (protons), and electrons which access active catalyst sites via pores in the catalyst layer, via proton conducting electrolyte adjacent to and within the catalyst layer, and via the electrically conducting catalyst and its support structure respectively. And at the cathode, the product species is gaseous or liquid water which is removed via the pores in the catalyst layer. Losses in performance associated with moving the more massive gaseous and liquid species to and from the catalyst via the pores are known as mass transport losses.

In typical solid polymer electrolyte fuel cell embodiments, the pore structure in the catalyst layer or electrode is not controlled. Instead, the pore structure can be a random result of the agglomeration for instance of supporting carbon particles along with other added particles and pore forming materials in the layer. Further, the distribution of catalyst and proton conducting ionomer in the electrode is also typically not directly controlled. As a result, the mass transport characteristics and catalyst utilization in a typical electrode are not as good as they might be in theory.

Numerous catalyst types, catalyst supports, and supporting structures have been suggested in the art. Agglomerate type electrodes comprising agglomerates of various particles arguably represent the state of the art at present. However, as mentioned above, such electrodes generally exhibit significantly less than ideal catalyst utilization and mass transport characteristics. Electrodes with more ordered catalyst support structures have also been proposed in the art. For instance, catalyst supports comprising metal meshes were suggested in US2006/0099482 and US2010/0047662. Meshes with relatively large open areas were involved, thus resulting in electrodes with relatively large pores. In the PhD thesis “On The Microstructure Of PEM Fuel Cell Catalyst Layers”, T. Sobolyeva, Department of Chemistry, Simon Fraser University, Fall, 2010, the microstructure of conventional catalyst layers of PEM fuel cells was investigated. It was suggested that mesoporous carbon supports should be investigated for fuel cell applications, including mesoporous materials with ordered networks.

The use of nano-carbon fibers as electrode supports has been suggested in the art. For instance, U.S. Pat. No. 8,017,284 discloses an electrode substrate composed of nano-carbon fiber in the form of a cloth or felt. The nano-carbon fiber substrate provides for an electrode substrate with better strength than an electrode substrate composed of a conventional carbonaceous material, and a pore size which can be controlled even though the composition for forming the catalyst layer may be coated in the form of a slurry.

Despite the research done to date, the mass transport characteristics of fuel cell electrodes and the distribution of catalyst and proton conducting material therein are still in need of improvement. The present invention addresses these and other needs as discussed below.

### SUMMARY

Use of an appropriate electrically conductive mesh as a catalyst support can provide for improved performance in solid polymer electrolyte fuel cells. The pore size of pores in the mesh should be between about 20 and 3000 nanometers. With appropriate selection of strand geometry in the mesh, suitable electrodes with essentially straight, parallel pores of engineered size can be obtained. A significant improvement in cell voltage at a given current can be expected when such electrodes are used as the cathode.

Specifically, the porous electrode comprises a support layer comprising an electrically conductive mesh, a catalytically active material supported on the mesh, and a proton conducting material distributed on the mesh and in contact with a portion of the catalytically active material. Further, the pore size of essentially all the pores in the electrode is between about 20 and 3000 nanometers. The electrically conductive mesh comprises at least first and second sets of strands in which the strands in each set are essentially straight and parallel. In this way, both the in-plane and the through-plane pores in the electrode can also be essentially straight and parallel, and thus the tortuosity of the pores in the electrode can desirably be less than about 1.5. In particular, the first and second sets of strands can be essentially orthogonal.

Appropriate strand geometry includes embodiments in which the spacing between each strand in each set (i.e. the distance between each strand absent catalytically active material and proton conducting material) is between about 20 and 3000 nanometers. As illustrated in the following Examples, the spacing can particularly be between about 20 and 200 nanometers. Further, the spacing between each strand in each set can essentially be the same. Further still, appropriate strand geometry includes embodiments in which the diameter of strands in the first and second sets is between about 20 and 3000 nanometers.

The strands in the first and second sets in the supporting mesh can be made of carbon, such as carbon fibres or carbon nanotubes. In addition, supporting mesh may comprise composite fibres with nanoplatelets, carbon nanotubes, oxides, polyaniline, and the like. The thickness of the supporting mesh, and hence the thickness of the electrode, can be between about 1 and 150 micrometers thick.

The invention is suitable for electrodes in which the catalytically active material is platinum and/or the proton conducting material is perfluorosulfonic acid polymer. And further, the invention is suitable for a solid polymer electrolyte fuel cell comprising a solid polymer electrolyte, an anode, and a cathode as described above.

The electrodes can be made by first obtaining an electrically conductive mesh or meshes with the desired characteristics. Catalytically active material can then be deposited onto the surface of the mesh, and followed by proton conducting material being distributed onto the catalytically active material deposited mesh. Various methods known in the art can be employed to deposit the catalytically active material, including wet depositing from solution, sputtering, or atomic layer deposition. And proton conducting material can be distributed thereon either by distributing ionomer onto the mesh and in contact with a portion of the deposited catalytically active material or alternatively by functionalizing the surface of electrically conductive mesh.

Electrodes may be contemplated in which more than one mesh geometry is employed. For instance, two meshes with different spacings between strands and/or different strand diameters may be stacked within an electrode and thus provide a support with a graded structure. In turn, this can provide an electrode with a desired gradient in porosity, catalyst loading, and/or ionomer content.

The open structure of the mesh based electrodes facilitates reactant and product flow in both the through-plane and in-plane directions of the electrode. Utilization of the catalytically active material can be improved as a result of the close proximity of catalytically active material to the reactant species flow paths. Tortuosities close to 1 can be achieved in principle, and the engineered electrode design allows for a continuous triple phase boundary for the reactants in principle. Further, with appropriate choice of meshes, the electrodes can be mechanically strong, stackable, and corrosion resistant. And from a manufacturing perspective, the properties of fabricated electrodes can be properly controlled by controlling the characteristics of the supporting mesh.

### BRIEF DESCRIPTION OF THE DRAWINGS

FIG. 1a shows an illustration of typical prior art electrode structures comprising carbon supported catalyst.

FIG. 1b shows a qualitative illustration of the pore size distribution in the typical carbon blacks used as catalyst supports.

FIG. 2a shows an isometric illustration of an electrode of the invention comprising a carbon mesh with orthogonal sets of strands.

FIG. 2b shows a cross-sectional illustration of the electrode in FIG. 2a.

FIG. 2c shows a close up view of the electrode in FIG. 2b.

FIG. 2d and FIG. 2e show illustrations of strands in an electrode in which a continuous film of catalytically active material and a partial coating of catalytically active material have been applied to the strands respectively.

FIG. 3 shows an exemplary illustration of an electrode of the invention comprising a carbon mesh with a gradient structure.

FIG. 4 compares the voltage versus current density plots for the modeled fuel cells in the Examples.

### DETAILED DESCRIPTION

In this specification, words such as “a” and “comprises” are to be construed in an open-ended sense and are to be considered as meaning at least one but not limited to just one.

Herein, in a quantitative context, the term “about” should be construed as being in the range up to plus 10% and down to minus 10%.

Mesh is intended to include semi-permeable barriers made of connected strands of metal, fibre, or other flexible or ductile material. Mesh includes webs, nets, and yarns with attached, woven, or interlocked strands.

In the context of a material, component, or step, the word “essentially” should be construed as including not only the material, component, and/or step as specified but also variations that do not materially affect the basic and novel characteristics thereof. For instance, mesh strands are to be construed as being essentially straight, parallel, and/or orthogonal if made approximately so, for instance, within present day capability for actual embodiments. Also for instance, the pore size of all the pores in an electrode are to be construed as essentially within a certain range if made approximately so, and in which the majority of the pores are in that range, within present day capabilities (and is thus intended to include electrodes having occasional larger pinholes or alternatively occasionally blocked or partially blocked pores).

Functionalization refers to introducing functional groups on a surface, such as a carbon fiber or nanotube surface in which the functional groups have a proton conducting ability (e.g. —SO₃⁻)

Improved electrodes for use in solid polymer electrolyte fuel cells are made using suitable electrically conductive meshes as engineered supports for catalyst and proton conducting material. When compared with typical conventional electrodes, pores of a preferred size and shape can be obtained.

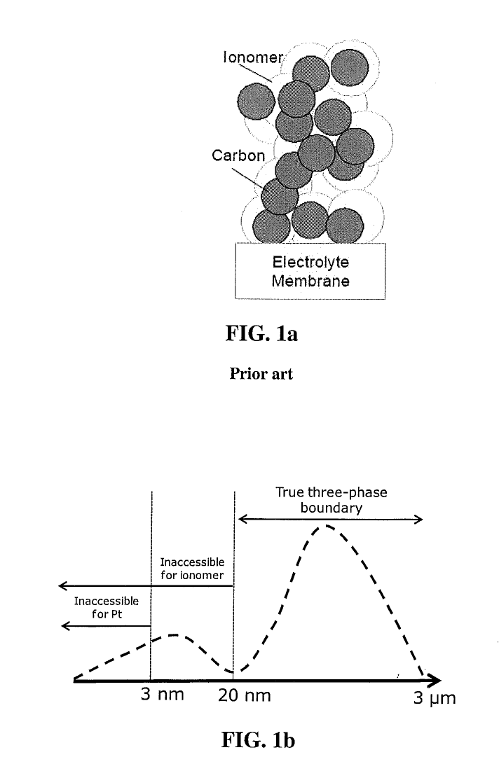

FIG. 1a shows a schematic illustration of typical prior art electrode structures comprising carbon supported catalyst (from M. Koyama, Multi-scale Simulation Approach for Polymer Electrolyte Fuel Cell Cathode Design, ECS Transactions, 16 (2) 57-66 (2008)). The electrode comprises an agglomerate of high surface area particulate carbon represented by the roughly spherical shaded circles in FIG. 1a. Catalytically active material (not shown in FIG. 1a) is deposited on the highly microporous surface of the carbon particles to achieve as great a surface area as possible. Proton conducting ionomer is dispersed over the agglomerate of carbon supported catalyst. An electrolyte membrane is also shown in FIG. 1a to illustrate how the electrode would be located in a fuel cell. From this figure it is evident how varied and tortuous the larger pores for mass transport can be within the agglomerate electrode. Generally, such electrodes and other random structured electrodes known in the art have tortuosities ranging from about 1.5 and up to 2.0.

FIG. 1b shows a qualitative illustration of the pore size distribution (dashed line) in the typical highly microporous carbon blacks used as catalyst supports in FIG. 1a. As illustrated in FIG. 1b, the pore size distribution is bi-modal, with peaks in the distribution curve in the micro-to-mesoporous region, a minor peak in the range from 1 nm to 20 nm in size and the major peak being about 50 nm in size. However, the typical Pt catalyst (size of order of 2-4 nm) employed in fuel cells does not deposit in pores below about 3 nm in size. And the typical perfluorosulfonic acid ionomer (size of order of 20-200 nm) employed in fuel cells does not get distributed in pores below about 20 nm in size. Thus, the presence of pores below about 20 nm in size is not so useful due to the absence of a three-phase boundary. And any valuable catalyst deposited therein is effectively wasted. On the other hand, while catalyst deposited in significantly larger pores can be accessed by all the reactant species, the presence of excessively large pores is counterproductive to obtaining the greatest possible surface area for catalyst.

Preferably therefore, a fuel cell electrode comprises pores greater than about 20 nm in size but below 3000 nm in size, and preferably well below 3000 nm in size. Further, for mass transport purposes, it is desirable for the pores to have close to ideal tortuosities of 1, and at least less than about 1.5. This kind of engineered electrode can be obtained by using an appropriate mesh support for the catalytically active material and ionomer (or other conducting material).

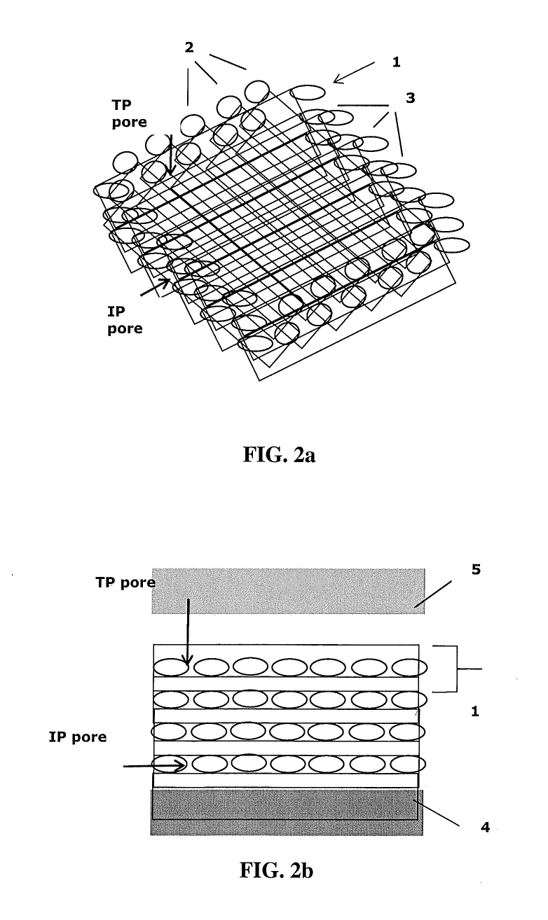

While meshes with various strand configurations and sizes may be contemplated, a simple illustrative embodiment is shown in FIG. 2a of an isometric view of an electrode comprising a carbon mesh with orthogonal sets of strands. Mesh 1 comprises two sets of orthogonal strands 2, 3. Further, as shown, the strands are stacked in alternating layers in which every other layer has the same orientation. A representative through-plane (TP) pore and representative in-plane (IP) pore are indicated with arrows in FIG. 2a. FIG. 2b shows a cross-sectional illustration of the electrode in FIG. 2a as it appears in a fuel cell. Mesh electrode 1 appears between adjacent membrane electrolyte 4 and gas diffusion layer 5.

FIG. 2c shows a close up illustrative view of the electrode in FIG. 2b. Pairs of alternating strands 2, 3 are coated with an essentially continuous deposit of Pt catalyst 6 (indicated in black). Ionomer 7 appears distributed onto catalyst 6. (Even in this idealized view, oxygen can access the Pt catalyst surface by permeating the thin film of ionomer.) FIG. 2d and FIG. 2e compare illustrations of strands in an electrode in which a continuous film of catalytically active material and a partial coating of catalytically active material have been applied to the strands respectively.

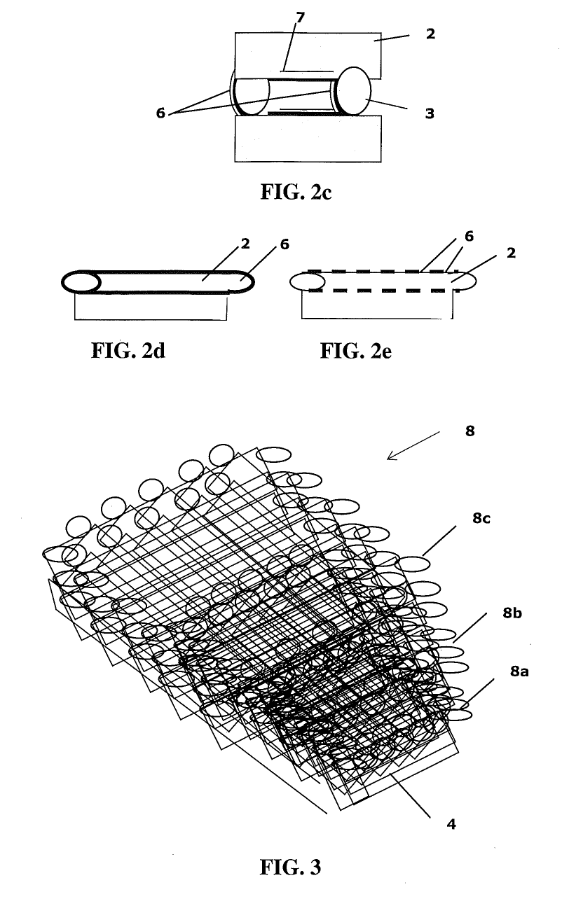

While FIGS. 2a-2e exemplify a simple embodiment of the invention, for certain reasons it may be advantageous to employ meshes in which the strands in each layer do not maintain the same orientation and/or size of the strands in every other alternating layer. Further, each set of strands need not be orthogonal and more than two sets of strand orientations may be employed. FIG. 3 for instance shows an exemplary illustration of an electrode of the invention comprising a carbon mesh with a gradient structure. Here, electrode 8 comprises a stack of three meshes 8a, 8b, 8c like that shown in FIG. 2a, but in which each mesh has strands of different size and spacing. As shown, the strand size and spacing in mesh 8b is greater than that in mesh 8a, and the strand size and spacing in mesh 8c is greater than that in mesh 8b. When employed in a fuel cell adjacent membrane electrolyte 4, this embodiment provides an electrode with discretely increasing pore size further from membrane electrolyte 4.

As discussed above, preferably the electrode has pores greater than about 20 nm in size but less than about 3000 nm in order that all the electrode surface is readily accessible yet without sacrificing surface area. Further, the strand dimensions should be sufficiently small such that surface areas equivalent to or greater than those provided by typical carbon blacks can be obtained (unless active metal can be deposited in the form of nanowhiskers or other high surface area nano-structure). Since the deposited catalytically active material and distributed proton conducting material occupy some volume, this means that a preferred supporting mesh may comprise strands from greater than about 20 nm to 3 μm in average diameter and have an open structure in which the strand spacings are also from greater than about 20 nm to 3 μm.

The overall electrode thickness is within conventional limits for the usual reasons but also has to take into consideration how electrode surface area varies with the strand characteristics. It is also possible for the mesh or meshes used not only to serve as a support for catalyst, and hence as an electrode, but also as an additional support or layer for other features in a fuel cell. For instance, a mesh may also serve as a gas diffusion layer or support for one. As an example, consider that the graded mesh structure shown in FIG. 3 could involve mesh 8a serving as a cathode support, mesh 8b perhaps as a sublayer, and mesh 8c as a gas diffusion layer. Thus, the thickness of the mesh employed may gainfully range from about 1 to 150 μm.

The mesh employed can comprise strands made from rods, fibers, nano-fibers, nano-fibre yarns, or the like. Composites including different carbon types (disordered and graphitic) or oxides (e.g. NbOₓ, TiO₂) may also be considered. The strands ultimately need to be electrically conductive and thus can desirably be made of conductive material, such as carbon. However, surface conductivity is sufficient and thus strands may, for instance, comprise non-conductive cores (e.g. cores of uncarbonized polymer). Meshes with appropriate strand size and spacings can be prepared from carbon nanotubes. Further, sheets of oriented nanotubes or whiskers are available which can be used to create stacked sheets and thus electrodes of variable thickness and having different properties in discrete layers.

Catalyst, typically platinum but also possibly other catalytically active materials, can be deposited onto an appropriately selected mesh in various ways. An idealized continuous uniform deposit is shown in FIGS. 2c and 2d. Typically however, the deposit of catalytically active material will comprise nano-particles, nano-whiskers, or nano-tubes as illustrated in FIG. 2e. Methods for depositing Pt include wet chemistry methods of Pt impregnation, electro-deposition, atomic layer deposition, sputtering and so forth (see for example: Sun et al., Adv. Mater. (2008) 20, 3900-3904, Controlled Growth of Pt Nanowires on Carbon Nanospheres and Their Enhanced Performance as Electrocatalysts in PEM Fuel Cells; Saha et al., Int. J. of Hyd. En. (2012) 37, 4633-4638, Carbon-coated tungsten oxide nanowires supported Pt nanoparticles for oxygen reduction; Zhao et al., Appl Phys A (2012) 106:863-869, Carbon nanotubes grown on electrospun polyacrylonitrile-based carbon nanofibers via chemical vapor deposition).

After application of catalytically active material, proton conducting material is distributed on the catalyst coated strands. This can be accomplished either by coating the mesh strands with ionomer or alternatively by surface functionalization of the strands. Any of various conventional methods may be employed to coat the mesh strands with ionomer. And surface functionalization (i.e. incorporation of chemical species to the surface) can be accomplished by a variety of processes including plasma, ALD (atomic layer deposition), CVD (chemical vapour deposition), or wet chemical methods and combinations thereof. Many reactions are facilitated by these processes including oxidation, sulfonation, phosphoration, arylation, acylation, etc. The functionalization may take place during the production of the fibres. Such groups may complement later functionalization processes and groups.

In an alternative approach, in principle the strands can be coated with catalytically active material and have ionomer distributed thereon before forming into a mesh. For instance, an option is to start with an appropriate carbon doped, electrically conductive fibre, platinize it, and dip in ionomer solution before winding up the fibre for later use in preparing a mesh product. Alternatively, fibres, such as fibres of polyaniline doped with carbon, could be sputtered with Pt before winding up for later use in preparing a mesh product. In a further option, composite yarns comprising wound fibre/s of electrically conducting material and fibre/s of ionomer may be prepared and platinized either before or after winding.

In yet other alternative approaches, a fabric-like mat of aligned carbon nanotubes may be considered as a support for catalytically active material. The mat may be seeded with material, e.g. Pt, and multi-armed starlike Pt nano-wires may be grown thereon. As another option, atomic layer deposition of Pt or other material may be used. Further still, graphene paper, if appropriately structured, may be employed as a possible support. Catalytically active material may be deposited in a like manner onto the graphene paper.

In a further approach, catalytically active material, such as Pt, may first be deposited onto graphene nano-platelets. An ink formulation can then be made comprising these Pt-deposited graphene nano-platelets and ionomer solution. Then, a suitably modified electro-spinning technique (e.g. of that disclosed in J. Electrochem. Soc., Vol. 158, Issue 5, pp. B568-B572 (2011)) may be used to apply the ink to a membrane electrolyte and result in the formation of a porous electrode of the invention.

As is known to those in the art, steps may be included to modify surface hydrophilicity and/or to include a loading of other materials in the electrode. Additional poreformers can also be included and, if necessary, later removed after the electrode is otherwise formed. And fuel cells employing the engineered electrodes can then be made in any conventional manner.

Without being bound by theory, it is believed desirable for the pores in fuel cell electrodes (both in-plane and through-plane pores) to have low tortuosity for mass transport purposes and to have a certain minimum pore size for accessibility of gases and product water. Use of mesh supports in accordance with the invention provides for control of pore size and shape and allows pores of very low tortuosity (e.g. essentially straight) to be engineered into the electrodes. Also it provides a desirable support for the distribution of catalytically active material and proton conducting material and an improved three phase boundary for reactions in the fuel cell.

The following Examples have been included to illustrate certain aspects of the invention but should not be construed as limiting in any way.

### EXAMPLES

The potential benefits of using engineered electrodes of the invention as cathodes in otherwise conventional fuel cells were obtained via modeling. In this modeling, conventional solid polymer fuel cell construction was assumed with the exception of certain cathode constructions of the invention. The cathode side of each cell comprised a cathode layer (CL) electrode, a cathode gas diffusion layer (GDL), and a microporous layer (MPL) between these two. The modeling itself was based on the Fuel Cell Simulation Toolbox (FCST), which is a simulation package for solid polymer electrolyte fuel cells. FCST is an open-source code and has an application that allows a user to simulate a cathode electrode. The physical models implemented in FCST are well validated with experimental data from the literature. A detailed description of the model theory, implementation and validation can be found for instance in M. Secanell, Computational modeling and optimization of proton exchange membrane fuel cells, Ph.D. thesis, University of Victoria, November 2007, and/or P. Dobson, Investigation of the polymer electrolyte membrane fuel cell catalyst layer microstructure, Master's thesis, University of Alberta, Fall 2011. However, the basic assumptions include a two-dimensional modeling domain, steady state and isothermal operation, no liquid water transport, negligible convection effects, gaseous species behave as ideal gases, and the transport of gases in the void phase and the transport of electrons in the solid phase are modeled using Fick's law and Ohm's law, respectively.

In all cases below, the parameters assumed for cell construction and for operation were:

### Design:

CL thickness: 5 μm
MPL thickness: 54 μm
GDL thickness: 250 μm
Cathode flow field channel width: 0.1 cm
Current collector width: 0.1 cm
Pt loading: 0.2 mg Pt/cm²

### Reference:

Reference ORR exchange current density: 1×10⁻⁶ A/cm²
Reference oxygen concentration: 3.451×10⁻⁵ mole/m³

### Properties:

Bulk electrical conductivity (carbon black): 88.84 S/cm
Bulk proton conductivity (Nafion 1100 electrolyte): Springer method

### Operating Conditions:

Cathode temperature: 68° C.
Air pressure at cathode: 2.5 bar
RH at cathode: 70%
   Note: the computational domain in the modeling was confined to the cathode half-cell, which includes cathode GDL, cathode MPL and cathode CL.

Several different fuel cell designs were then considered in this modeling. A comparative fuel cell (denoted Comparative) was modeled which had a conventional cathode as described above. Two fuel cells of the invention were also modeled in which the cathodes comprised a carbon fibre mesh with orthogonal alternating strand (fibre) sets as shown in FIGS. 2a and 2b. The mesh itself was assumed to comprise fibres with diameters of 50 nanometers. The spacing between fibres (without applied catalyst or ionomer) was also assumed to be 50 nanometers. And the overall thickness of the meshes was assumed to be 5 micrometers.

In the cathode of the first inventive cell (denoted Mesh 100% coated), the catalytically active material was assumed to be distributed as a continuous uniform film, evenly applied over the entire surface area of the mesh (e.g. as illustrated in FIG. 2d). In the cathode of the second inventive cell (denoted Mesh 50% coated), the catalytically active material was assumed to appear as discrete partial coatings so as to more closely mimic an application of nanoparticles. The partial coating here was assumed to be applied over 50% of the available mesh surface (e.g. as illustrated in FIG. 2e). In all cases though (comparative and inventive), the total catalyst loading was the same 0.2 mg Pt/cm². For modeling purposes, ionomer was assumed to be present as a uniform, gas permeable film over the mesh supported catalyst surface with a thickness of 5 nanometers (e.g. as illustrated in FIG. 2c).

The porosity of each cathode was determined by calculation based on geometrical considerations for the inventive cathodes and by experiment for the comparative cathode. The ECSA (electrochemical surface area) of 100 cm²(Pt)/cm²(catalyst layer) for the comparative cathode was based on both literature and measurements of actual conventional electrodes. The ECSA for the inventive cathodes were based on the geometric area of the fibres and assumed that the coated areas were completely active. Tortuosity values for oxygen diffusion and proton conductivity were taken from the literature for the conventional cathode. The tortuosity values for oxygen diffusion for the inventive cathodes were assumed to be 1 as a result of having essentially straight pores. The tortuosity values for proton conduction were calculated based on the geometry of the mesh fibres (the path for protons is not straight and is instead a semi-circular path from fibre to fibre at the points where fibres overlap).

Table 1 summarizes the cathode characteristics for these different cathodes along with porosity, ECSA, and tortuosities for oxygen diffusion and proton conduction.

TABLE 1

| | Comparative | Mesh 100% coated | Mesh 50% |
|---|---|---|---|
| Parameter | cell | cell | coated cell |
| Fibre diameter (nm) | NA | 50 | 50 |
| Fibre spacing (nm) | NA | 50 | 50 |
| Cathode thickness (μm) | 5 | 5 | 5 |
| Pt loading (mg/cm²) | 0.2 | 0.2 | 0.2 |
| Ionomer thickness (nm) | 5 | 5 | 5 |
| Cathode porosity | 0.46 | 0.48 | 0.48 |
| ECSA (cm²/cm²) | 100 | 110 | 55 |
| Tortuosity (O₂ diffusion) | 1.5 | 1.0 | 1.0 |
| Tortuosity (H⁺ | 1.5 | 1.3 | 1.3 |
| conduction) | | | |

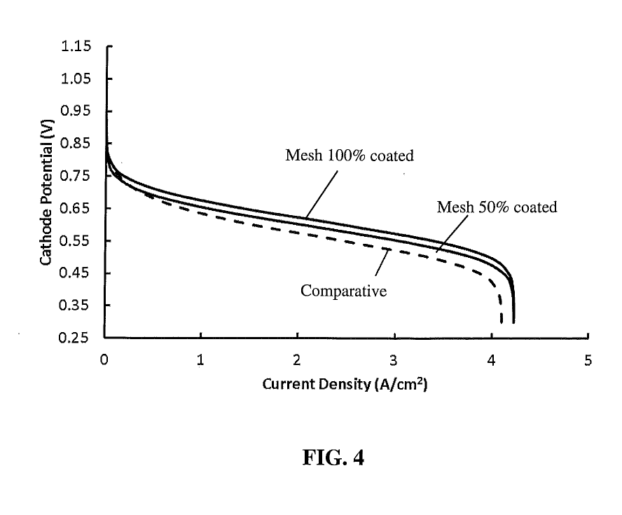

Polarization results (voltage output versus current density) were calculated for the cells and are plotted in FIG. 4. As is evident from FIG. 4, the Mesh 50% coated cell showed a significant improvement in performance over the Comparative cell. The Mesh 100% coated cell showed an even greater improvement in polarization characteristics.

Further modeling was done to determine the expected effects of varied fibre diameter and spacing within the mesh. The models considered here were based on meshes with fibres as in the preceding or greater in size. In all cases the catalytically active material was assumed to be distributed as a continuous uniform film over the entire surface area of the mesh. Specifically, meshes in which both the fibre diameter and the spacing between fibres were either 50 nm, 100 nm, 200 nm, or 500 nm were considered. Otherwise the models assumed similar thickness, Pt loadings, and ionomer thickness as in the preceding.

Polarization characteristics were calculated for each of these models. The plot for the cell whose cathode contained 50 nm fibre mesh appears in FIG. 4. The results for the cell with the 100 nm fibre mesh cathode were not as good as that for the cell with the 50 nm fibre mesh cathode but were better than the Comparative cell. The polarization results for the cell with the 200 nm fibre mesh cathode were slightly inferior to that of the Comparative cell. And finally, the results for the cell with the 500 nm fibre mesh cathode were slightly inferior to that of the 200 nm fibre mesh cathode cell. Thus, a definite trend was seen with increasing fibre size and spacing. In these embodiments, performance improvement could be obtained using meshes with fibre sizes and spacings smaller than 200 nm.

In addition, modeling was done to determine the expected effects of varied overall mesh thickness. The models considered here compared mesh thicknesses of 5 micrometers (as above) to a thicker version which was 10 micrometers thick. In both models, the total catalyst loadings on each electrode were the same and similar ionomer thicknesses were assumed (thus the thicker mesh had a thinner deposit of catalyst and a greater loading of ionomer).

Polarization characteristics were calculated for each of these models. The plot for the cell with the 5 μm thick mesh appears in FIG. 4. The results for the cell with the 10 μm thick mesh cathode were significantly better than the cell with the 5 μm thick mesh.

These Examples demonstrate that use of appropriately engineered meshes as electrode supports can provide for improved performance in solid polymer electrolyte fuel cells.

All of the above U.S. patents, U.S. patent application publications, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings.

What is claimed is:

1. A porous electrode for a fuel cell comprising a support layer comprising an electrically conductive mesh, a catalytically active material supported on the mesh, and a proton conducting material distributed on the mesh and in contact with a portion of the catalytically active material wherein the electrically conductive mesh comprises at least first and second sets of strands and the strands in each set are essentially straight and parallel,
wherein the pore size of essentially all the pores in the electrode is from about 20 to 3000 nanometers.

2. The electrode of claim 1 wherein the spacing between each strand in each set is from about 20 to 3000 nanometers.

3. The electrode of claim 2 wherein the spacing between each strand in each set is from about 20 to 200 nanometers.

4. The electrode of claim 1 wherein the tortuosity of the pores in the electrode is less than about 1.5.

5. The electrode of claim 1 wherein the first and second sets of strands are essentially orthogonal.

6. The electrode of claim 1 wherein the strands in the first and second sets comprise carbon.

7. The electrode of claim 6 wherein the strands in the first and second sets are carbon fibres or carbon nanotubes.

8. The electrode of claim 1 wherein the diameter of strands in the first and second sets is from about 20 to 3000 nanometers.

9. The electrode of claim 1 wherein the spacing between each strand in each set is essentially the same.

10. The electrode of claim 1 wherein the mesh is from about 1 to 150 micrometers thick.

11. The electrode of claim 1 wherein the catalytically active material is platinum.

12. The electrode of claim 1 wherein the proton conducting material is perfluorosulfonic acid polymer.

13. A solid polymer electrolyte fuel cell comprising a solid polymer electrolyte, an anode, and a cathode wherein the cathode is the electrode of claim 1.

14. A method of making the electrode of claim 1 comprising:
obtaining the electrically conductive mesh;
depositing the catalytically active material onto the surface of the mesh; and
distributing the proton conducting material onto the catalytically active material deposited mesh.

15. The method of claim 14 wherein the electrically conductive mesh comprises carbon fibres or carbon nanotubes.

16. The method of claim 14 wherein the catalytically active material depositing comprises wet depositing from solution, sputtering, or atomic layer depositing.

17. The method of claim 14 wherein the distributing comprises distributing ionomer onto the mesh and in contact with a portion of the deposited catalytically active material or functionalizing the surface of electrically conductive mesh.

18. A method of making a solid polymer electrolyte fuel cell comprising a solid polymer electrolyte, an anode, and a cathode, the method comprising incorporating the electrode of claim 1 as the cathode.
